(19) United States
(12) Patent Application Publication
(10) Pub. No.: US 2018/0124156 A1
(43) Pub. Date: May 3, 2018

(54) LOADER AND METHOD FOR PROCESSING A RESOURCE BUNDLE

(71) Applicant: Gamesys Ltd., London (GB)

(72) Inventor: Richard Livingston, Welwyn Garden City (GB)

(21) Appl. No.: 15/802,449

(22) Filed: Nov. 2, 2017

Related U.S. Application Data
(60) Provisional application No. 62/416,678, filed on Nov. 2, 2016.

(51) Int. Cl. H04L 29/08; G06F 9/445; G06F 9/50

(52) U.S. Cl. CPC H04L 67/06; G06F 9/505; G06F 9/5083; G06F 9/44578

(57) ABSTRACT

In accordance with some embodiments, a loader is operable to download a resource bundle from a server to a user device and process/load at least one resource included in the resource bundle before the whole resource bundle is downloaded. A novel data structure for the resource bundle header and the resources of the bundle allows the loading of the resources into a program as the resource bundle continues to be downloaded, thus decreasing the time between a start of the download and a time at which the resources included in the resource bundle are available for use by the program.

### CLAIM OF PRIORITY

The present application claims the benefit of prior-filed U.S. provisional application No. 62/416,678, filed on Nov. 2, 2016 in the name of Richard Livingston and titled SYSTEMS AND METHODS FOR LOADING A BUNDLED RESOURCE DATA FILE AT A USER DEVICE FOR USE IN AN ONLINE GAME. The entirety of this provisional application is incorporated by reference herein for all purposes.

### INTRODUCTION

The present disclosure relates to the downloading of large files or data (or a large number of files or data), such as files or data for use in an online game (e.g., files or data representing resources for use in facilitating play of the online game). In particular, embodiments described herein are directed to systems and methods for (i) decreasing the time required to download and use such files or data in a game, (ii) increasing the efficiency of the downloading and processing for use of such files or data and/or (iii) decreasing the latency involved in the downloading of a large number of files or large amounts of data. At least some of the embodiments described herein may be applicable to any environment in which data and/or files (e.g., graphics, text, audio) need to be downloaded to a user device and loaded into an application (e.g., a game or other software application) for use by a program of the application (e.g., for use by the game program). The systems and methods described herein minimize the time necessary to download and process such data or files, thus allowing a user to enjoy the game or other application sooner.

In the environment of computer networks and transmitting data over a computer network to a receiving computing device in order to facilitate a game or other software application that utilizes such data, Applicant has recognized that prior art methodologies are undesirably inefficient, resulting in the downloading of such data over a computer network and subsequent processing of such data such that it can be utilized in the play of an online game taking an undesirable duration of time, thus delaying a player's enjoyment of the game. For example, in the case of an online game that requires a large amount of data (e.g., data comprising sound, text and/or graphical resources that are components of the game) to be downloaded to a user device over the Internet via a web browser of the user device, even a relatively small delay in the downloading and processing of the data such that it can be utilized within the game may cause frustration on the part of the user and/or cause the user to abandon the download process and/or play of the game. In cases where a user device connection to a game server is particularly slow (e.g., a user device comprising a mobile device is accessing data from a game server via a slow Wi-Fi or other mobile connection), prior art methodologies can be particularly frustrating and unduly time-consuming.

For example, some online games utilize a process in which multiple resources needed for the game are converted into base64 encoded strings, which are then compiled into a JSON file which is downloaded to a user device and decoded using JavaScript. This process, however, is unduly time consuming at least because it results in a 33% increase in file size compared to the original resource files/data (and thus a 33% increase in download time) because the process does not support binary data and requires encoding of the underlying data. This process also requires the entire large file to be downloaded before it can be processed and the resources loaded into the game. Further, audio resources require additional processing in this methodology. For example, if the application (e.g., game) uses Web Audio (the method used for playing audio in most browsers and which utilizes the above-described base64 encoding methodology), the Web Audio API will require extra and time-consuming steps, such as first decoding the base64 string (e.g., by using the browser's atob function), and then looping over each character in the decoded string, and inserting its character code into a buffer. Or otherwise decoding the data before building the audio data buffer. In scenarios in which a user device is experiencing slow connectivity (e.g., the user device is experiencing a slow mobile data communication) such prior art processes may result in a user giving up the attempt to download data in order to play a game (or utilize another application requiring the downloading of large amounts of data) or the process may discontinue mid-way due to one or more of the multiple HTTP requests to the server being unsuccessful or a slow response time from the server.

There is therefore a need for systems and methods which allow for more efficient downloading and/or processing (e.g., extracting from a bundle and loading into a program for use by the program) of resources for a game or for any environment or application that requires the downloading and processing (e.g., loading into a game or other application) of large amounts of data (e.g., data comprising multiple resources which are components usable within the game or other application) over the Internet, including web pages, mobile applications and desktop based applications. There is also a need for systems and methods that allow for faster and more efficient downloading and loading of resources into a program.

In accordance with some embodiments, multiple resources (or data comprising multiple resources) for a given application (e.g., online game) are compiled into a single file referred to herein as a Resource Bundle, the Resource Bundle being formatted in accordance with novel data structures and protocols and being readable by a loader on a user device that is configured to read the novel data structures. The Resource Bundle may be made available by a server (e.g., a game server) for downloading to a user device (e.g., via a web browser of a user device (also referred to herein as a player device, in the context of a game application)), such as over HTTP. In accordance with some embodiments, a Resource Bundle is downloaded responsive to a single HTTP request from a user device. The Resource Bundle may be generated using Javascript or any other computer language that is appropriate. The particular process for compiling the data into the single file or Resource Bundle (described herein) allows for a large number of resources (e.g., 100-150) to be transmitted as a single file and in response to a single HTTP request, which reduces latency. The processes and data structures described herein allow for a novel method of formatting a Resource Bundle using a data structure that supports binary data (and thus does not require the encoding of prior art methods, such as the base64/JSON structure which results in approximately a 33% increase in file size and thus corresponding increase in download time). Further, the novel processes and data structures described herein provide for Resource Bundle formatting and protocols that, in conjunction with an appropriately programmed loader that is configured to read the format of the Resource Bundle data structures, allow for the processing of individual resources included in a Resource Bundle and loading of such resources into a program as they are downloaded and while the download of the remainder of the Resource Bundle continues. This is in contrast to conventional methods in which an entire Resource Bundle needs to be downloaded before processing and loading of the resources begins. Benefits of the embodiments described herein include allowing a user to enjoy the benefits of the resources sooner (by having the resources loaded and available for use by the program in less time from the time a download of a Resource Bundle is initiated), improving the efficiency with which a computer and program operate by providing for the downloading and processing of resources in a Resource Bundle to occur in parallel rather than series and decreasing the total time for download and processing of a Resource Bundle, thus freeing up processing resources of a computing device sooner.

### BRIEF DESCRIPTION OF THE FIGURES

An understanding of embodiments described herein and many of the attendant advantages thereof may be readily obtained by reference to the following detailed description when considered with the accompanying drawings, wherein:

FIG. 1 comprises a schematic diagram of an example system for implementing at least some embodiments described herein, in accordance with some embodiments;

FIG. 2 comprises a schematic diagram of an example system for implementing at least some embodiments described herein, in accordance with some embodiments; and

FIG. 3 comprises a schematic diagram illustrating how a Resource Bundle may be downloaded and processed to a user device, in accordance with some embodiments.

FIGS. 4A and 4B together illustrate two example data structures that may be utilized by a Resource Bundle generator in order to allow a loader to process and load resources of a Resource Bundle while the remainder of the Resource Bundle continues to be downloaded.

FIG. 5 illustrates an example embodiment consistent with at least some embodiments.

### DETAILED DESCRIPTION

In accordance with some embodiments, processes, data structures and protocols for generating Resource Bundles, along with an appropriately configured loader and processes for downloading and processing the Resource Bundle provide for facilitating the transmission of data comprising resources or elements usable in a software program or application (e.g., an online game program). Examples of such resources include, without limitation, graphics, text, video and/or audio files. Such facilitating may comprise compiling the data representing a plurality of individual resources into a single file or Resource Bundle, which may be compiled in a particular format and in accordance with a particular protocol, as described herein. The Resource Bundle may be stored in a memory of a server (e.g., a game server, in the application of an online game). In response to a request a Resource Bundle (e.g., an HTTP request transmitted from the user device to the server, whether directly or indirectly), the Resource Bundle may be transmitted to, or downloaded by, the user device (e.g., via a web browser of the user device). In accordance with some embodiments, the user device has first downloaded or otherwise acquired in its memory a software application (e.g., a game program). For example, the game program may be transmitted by a game server first, prior the Resource Bundle being transmitted. In accordance with some embodiments, the game program may include a Bundle Loader module, which may be a sub-program or part of the game program that is operable to process the data comprising a Resource Bundle (e.g., uncompile, extract or otherwise retrieve the data/resources from the Resource Bundle into a form usable by the game program and load it into the game, make it available for utilization by the game program or store it in a memory accessible to the game program).

In some embodiments, the Bundle Loader module may be a stand-alone program or module stored on a user device that is operable to receive and process any Resource Bundle that is formatted and generated in accordance with the embodiments described herein. For example, in some embodiments the Bundle Loader module may be agnostic as to the program (whether a game program or otherwise) for which a Resource Bundle is destined, it may be operable to receive, process and provide data from Resource Bundles to different programs or applications (e.g., even ones associated with different providers/sources).

In accordance with some embodiments, systems, methods and articles of manufacture may provide for a Bundle Loader software module (e.g., whether as part of a larger game program or as a stand-alone program stored on or accessible to a user device) that is operable to extract data from a Resource Bundle (e.g., a compilation of data representing a plurality of resources usable in a software application such as an online game) and make the data (e.g., the resources) available for utilization by the online game or other software application for which the data is intended. In accordance with some embodiments, the Bundle Loader may be operable to extract or uncompile the data in a Resource Bundle while the remainder of the Resource Bundle is still being downloaded to a user device (e.g., once a certain threshold of data has been downloaded or other criteria has been satisfied, as described herein), thus shortening the time required for downloading the Resource Bundle and making the resources available for utilization by the software application (e.g., online game) for which the resources are intended. In accordance with one embodiment, the data of a Resource Bundle may be encoded and formatted in a particular manner and the Bundle Loader may be operable to process the data by decoding it and recognizing the formatting in order to extract the information necessary to process the data in the Resource Bundle.

Certain aspects, advantages, and novel features of various embodiments of a roulette game are described herein. It is to be understood that not necessarily all such advantages may be achieved in accordance with any particular embodiment. Thus, for example, those skilled in the art will recognize different embodiments may be implemented or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game). In accordance with some embodiments, a player may be a type of user.

Some embodiments described herein are associated with a “player device”, “user device” or a “network device”. As used herein, a “player device” is a subset of a “network device” or a “user device”. The “network device”, for example, may generally refer to any device that can communicate via a network, while the “player device” may comprise a network device that is owned and/or operated by or otherwise associated with a player. In another example, a “user device” may comprise a personal device of a user who desires to use a software application that requires resources that may be transmitted as a Resource Bundle, and a “player device” may be a user device usable in an embodiment in which the software application comprises a game. Examples of player, user and/or network devices may include, but are not limited to: a Personal Computer (PC), a computer workstation, a computer server, a printer, a scanner, a facsimile machine, a copier, a tablet computer, a smart phone, a Personal Digital Assistant (PDA), a storage device (e.g., a disk drive), a hub, a router, a switch, and a modem, a video game console, or a wireless or cellular telephone. Player, user and/or network devices may, in some embodiments, comprise one or more network components.

An “game event”, “event instance”, “game instance”, “spin” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

The various features and embodiments described herein may be combined as appropriate, as would be apparent to a skilled person up on reading the present disclosure, and need not be combined strictly in the manner described herein. Throughout the drawings, like reference symbols refer to like features or steps.

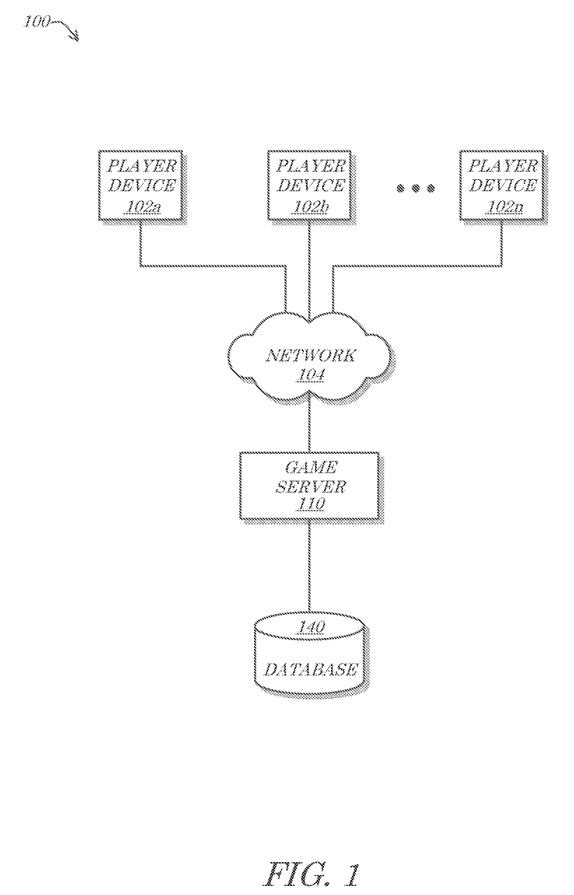

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments, the database 140 may store one or more Resource Bundles, available for transmission to a player device (e.g., in response to an HTTP request for a Resource Bundle). In some embodiments, the database 140 or another memory may be operable to store a plurality of different Resource Bundles (e.g., different Resource Bundles corresponding to different games available via the game server 110).

In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts. In accordance with some embodiments, a processor of game server 110 or a processor of another server may be operable to compile a Resource Bundle in accordance with protocols or processes as described in more detail elsewhere herein.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) for an event instance, spin or turn of a game, (ii) a current state or status of a game or game session, (iii) one or more user interfaces for use in a game, (iv) one or more game themes for a game and/or (v) profiles or other personal information associated with a player of a game. In some embodiments, the game server may store one or more game programs and/or one or more Resource Bundles for transmitting to a player device and a player device may store one or more game programs and/or one or more resources extracted from a Resource Bundle once the foregoing are downloaded to the player device. It should be noted that in some embodiments data such as a game program may be stored on the game server 110 and information based on such data may be output to a player device 102 during play of a game while in other embodiments a game program may be downloaded to a local memory of a player device 102 and thereafter the game program may be stored on or accessible to a player device 102 (e.g., in encrypted or other secure or tamper-resistant form, in a cache of a web browser of the game server, etc.).

A game server 110 may comprise a computing device for facilitating play of a game (e.g., by receiving an input from a player, determining outcomes for a game, making a game program and/or Resource bundle available to a player device, facilitating a wager and/or a provision of a payout for a game). For example, the game server 110 may comprise a server computer operated by a game provider or another entity (e.g., a social network website not primarily directed at providing games). In some embodiments, the game server may determine an outcome for spin of a game by requesting and receiving such an outcome from another remote server operable to provide such outcomes. In some embodiments, the game server 110 may further be operable to facilitate a game program for a game (e.g., a wagering game). In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator).

Examples of processes that may be performed by the game server 110 (directly or indirectly) may include, but are not limited to: (i) determining an initial outcome (i.e., an outcome prior to any replacing of symbols) for a player; (ii) compiling a Resource Bundle; (iii) transmitting a game program and/or Resource Bundle to a player device; (iv) transmitting an indication of outcomes for a game to a player device; (vii) authorizing a game program to be downloaded to a player device; and/or (viii) modifying (or directing a player device to modify) a game interface which is outputting information for a game.

In accordance with some embodiments, a game server or other device may compile a Resource Bundle in accordance with particular protocols and/or storing data in a Resource Bundle in accordance with a particular format. In some embodiments, a library or plurality of Resource Bundles may be pre-generated and stored in a memory of a device (e.g., a memory of a game server) and a particular Resource Bundle may be downloaded to a user device in response to a request for a particular Resource Bundle from the user device.

In some embodiments, the data in a Resource Bundle is arranged as follows: <HEADER><ENTRY #1><ENTRY #2><ENTRY #3><ENTRY #n> (wherein “ENTRY” comprises a resource included in the Resource Bundle). In such an arrangement, the data is downloaded and read sequentially in the order illustrated. The following example data structures may be utilized in some embodiments to compile a Resource Bundle and store data representing resources in the Resource Bundle. In some embodiments, a Resource Bundle may comprise a binary file comprising the raw data representing the resources in the Bundle (e.g., the data is not encoded).

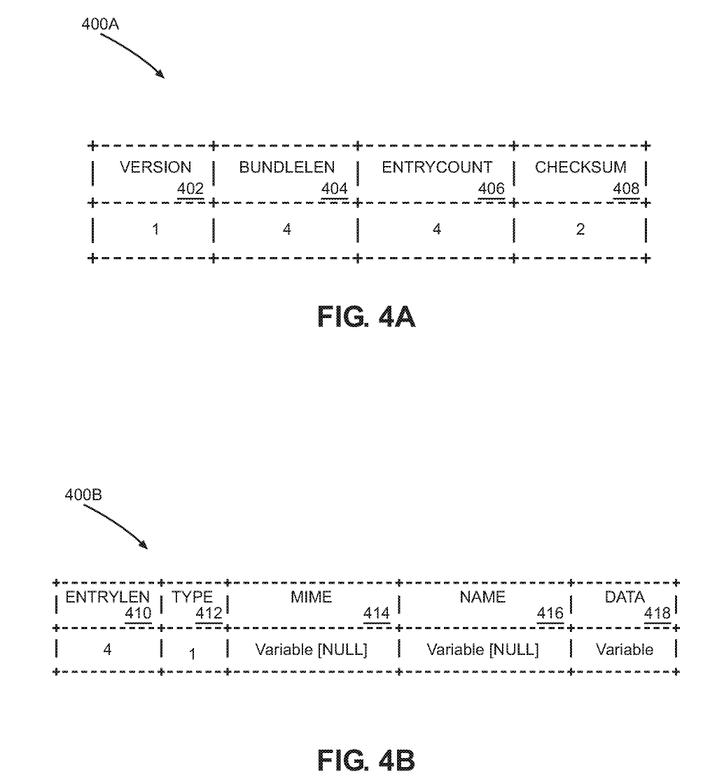

FIGS. 4A and 4B, described below, illustrate example data structures for how the data defining a Resource Bundle may be formatted or structured such that it can be downloaded and processed more efficiently than it currently is utilizing conventional practices, and particularly such that it may be processed and resources included in the Resource Bundle may be loaded prior to a completion of a download of the Resource Bundle.

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox360™, Sony™ Plasystation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102. In some embodiments, a player device may comprise a dongle or other computing device which does not include an input or output device but is operable to be plugged into another device (e.g., a television, s set-top box or other computing device) and be operable to receive input of information and output information via components of the other device.

A player device 102 may be used to play a wagering or non-wagering game (e.g., a social or casual game) over a network and output information relating to the game to players participating in the game (e.g., outcomes for an event instance of the game, qualifying for a bonus round of the game, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In some embodiments, a player device may comprise a web browser via which the player device may access, download and/or store game data (e.g., a game program and/or resources transmitted via a Resource Bundle).

In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110. It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102.

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

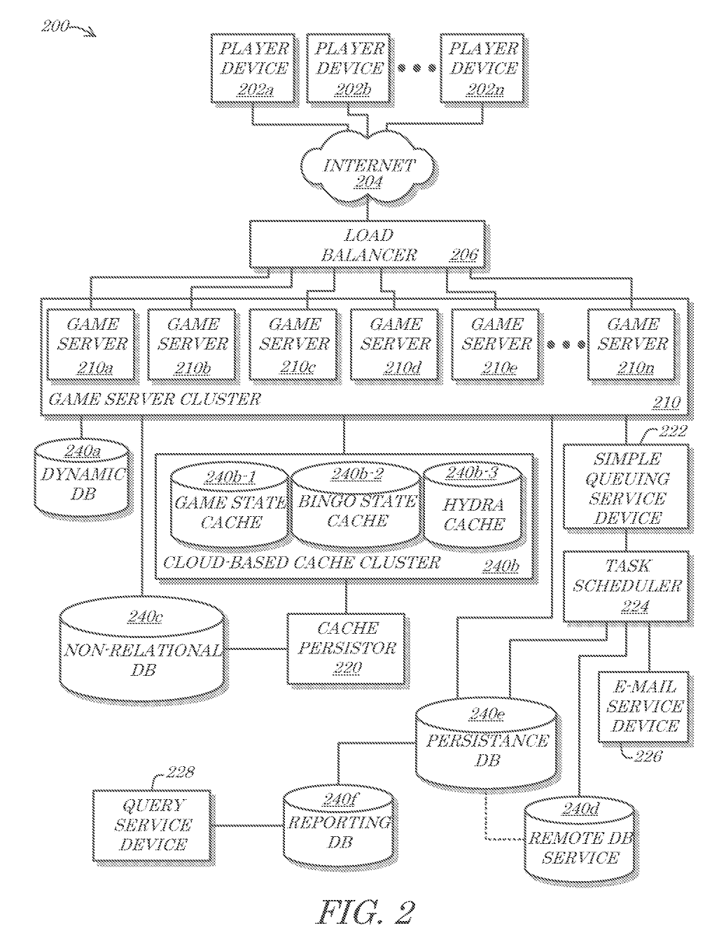

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online game of a first type (or tournament), a second game server 210c may host a second particular instance of the online game of the first type (or tournament), a third game server 210c may facilitate an online game of a second type, and/or a fourth game server 210d may provide an online game of a third type.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f The query service 228 may then be utilized, for example, to query the reporting DB 240f, without taxing the live environment and/or production system directly accessible by the game server cluster 210.

As described herein, in accordance with some embodiments a software application or program may be downloaded to, made accessible to and/or installed onto a computing device (e.g., a player device or server device), for facilitating one or more functions, programs or processes described herein. Such a software application or program may further comprise one or more software module(s) for directing a processor of the player device to perform certain functions. In accordance with some embodiments, software components, applications, routines or sub-routines, or sets of instructions for causing one or more processors to perform certain functions may be referred to as “modules”. It should be noted that such modules, or any software or computer program referred to herein, may be written in any computer language and may be a portion of a monolithic code base, or may be developed in more discrete code portions, such as is typical in object-oriented computer languages. In addition, the modules, or any software or computer program referred to herein, may in some embodiments be distributed across a plurality of computer platforms, servers, terminals, and the like. For example, a given module may be implemented such that the described functions are performed by separate processors and/or computing hardware platforms.

In one example embodiment, a game program may be downloaded by a player device and the game program may include a Bundle Loader module. The Bundle Loader module may function, in accordance with some embodiments, to process the data comprising a Resource Bundle being downloaded to the player device. For example, the Bundle Loader module may function to extract the data comprising the individual resources included in the Resource Bundle and render them usable by the game program (e.g., store them in an appropriate memory, portion, format and/or element of the game program such that the resource(s) are available as needed by the game program).

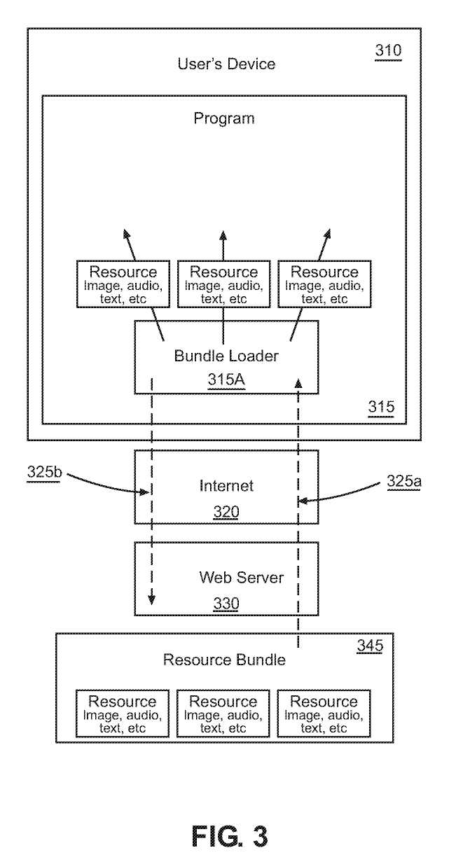

Referring now to FIG. 3, illustrated therein is one embodiment of a schematic diagram illustrating system architecture and a process for how (i) a Resource Bundle may be generated and stored by one or more server devices; (ii) downloaded to a user device 310 (e.g., a player device, such as a player device 120 of FIG. 1); and (iii) processed by a Bundle Loader module 315A of a game program 315 (or another type of program, in applications other than online games). In accordance with some embodiments, the game program 315 may have previously been downloaded to the user device (e.g., via a web browser of the user device) and/or may be stored at the user device (e.g., in a local memory of the user device or in a cache memory of the web browser). A Bundle Loader module 315A is an example of a loader. A loader, as the term is used herein unless indicated otherwise, may comprise a mechanism (e.g., software module or application) configured to support processing of resources included in a Resource Bundle received from a server or other device and the loading of the resources into a program or application (such as the game program 315).

In accordance with some embodiments a Resource Bundle is generated and stored or hosted at web server or other server device, ready for downloading to a user device. In accordance with some embodiments, the Resource Bundle is generated using protocols and data structures such as that described herein, and particularly with reference to FIGS. 4A and 4B, such that the header data structure and each entry (resource) data structure allows the Bundle Loader to process and load the resources in parallel with continuing the download of the remainder of the Resource Bundle. In some embodiments, a game server (or server of another type of program that requires resources to be downloaded and processed into the program) includes a Resource Bundle generator mechanism that is programmed to generate Resource Bundles using the data structures and formatting described herein. A Resource Bundle may comprise a binary file containing raw resource data and metadata, as described with reference to FIGS. 4A and 4B.

In accordance with some embodiments, the Bundle Loader may request the Resource Bundle from the web server over HTTP (e.g., in a single HTTP request or a minimal number of HTTP requests, to minimize latency). The requested Resource Bundle is transmitted to the Bundle Loader over the Internet 320 via the Web Server 330. It should be noted that in some embodiments (e.g., in embodiments in which the software application to which the resources are applied comprises a game) the Web Server 330 may comprise a game server 110 (FIG. 1) or the game server cluster 210 (and/or one or more of the game servers 210a-n thereof; FIG. 2). In the example of FIG. 3, three resources are illustrated as being included in the Resource Bundle 345 but it should be understood that a much larger number of resources may be included in a Resource Bundle (e.g., 100-150 resources).

In accordance with some embodiments, the Bundle Loader is operable to process the Resource Bundle while it is being downloaded (e.g., before the entire file comprising the Resource Bundle has been completely downloaded) and is programmed to recognize where in the game program each type of resource or each resource should be placed. For example, the Bundle Loader may be programmed to process the data included in a Resource Bundle upon determining that certain criteria are satisfied (e.g., sufficient data has been processed for a particular entry/resource to allow for the processing and loading of that resource into a game program) and/or at certain predetermined intervals or in response to certain triggering conditions. Thus, resources may be processed before the entire download has completed, as the data is streamed. In one example embodiment, as the download of the Resource Bundle progresses, the available data may be inspected at intervals and, if the available number of unprocessed bytes is at least equal to the next resource entry's ENTRYLEN variable then at least one more resource is processed.

In some embodiments, a loader may not be a module of the program into which it is configured to load resources but may rather be a stand-along program that is operable to interface with different programs or applications (e.g., programs from entities different than the entity that provides the loader). In some embodiments, a loader may include communication interfaces that support communication with external applications. In some embodiments, the loader may be made available as a library which could be utilized by any other program, provided the program knows how to interact with the library. For example, a vendor that provides Resource Bundles to the loader would need to ensure that their resources were contained in a Resource Bundle format compatible with the loader (e.g., a format such as described with respect to FIGS. 4A and 4B) and a game program provider that desires for the game program to be able to obtain resources from the loader/library would need to ensure that the game program is configured to interface with the loader in order to obtain the resources from a Resource Bundle downloaded and processed by the loader. Thus, so long as a Resource Bundle is formatted in a manner that is compatible with the loader, the Resource Bundle may be processed by the loader irrespective of whether the Resource Bundle and the loader were generated by the same entity or provider.

In some embodiments, the data in a Resource Bundle is arranged as follows: <HEADER><ENTRY #1><ENTRY #2><ENTRY #3><ENTRY #n> (wherein “ENTRY” comprises a resource included in the Resource Bundle). In such an arrangement, the data is downloaded and read sequentially in the order illustrated. The following example data structures may be utilized in some embodiments to compile a Resource Bundle and store data representing resources in the Resource Bundle. In some embodiments, a Resource Bundle may comprise a binary file comprising the raw data representing the resources in the Bundle (e.g., the data is not encoded).

FIGS. 4A and 4B illustrate example data structures for how the data defining a Resource Bundle may be formatted or structured such that it can be downloaded and processed more efficiently than it currently is utilizing conventional practices, and particularly such that it may be processed and resources included in the Resource Bundle may be loaded prior to a completion of a download of the Resource Bundle.

FIG. 4A illustrates a table 400A that is an example data structure for a header of a Resource Bundle. FIG. 4B illustrates the data structure in the form of a table 400B, representing how each entry or resource included in the Resource Bundle may be formatted. In accordance with at least some embodiments, the information of both the data structure of table 400A (the structure of the header for the Resource Bundle) and the data structure of table 400B (the structure of the entry where each entry contains a resource), each formatted in the particular manner described herein, are required in order for a Bundle Loader module to be able to process a Resource Bundle and load the individual resources while the download of the Resource Bundle is still ongoing.

Turning first to FIG. 4A, the table 400A defines four (4) example columns or fields: (i) a VERSION field 402; (ii) a BUNDLELEN field 404; (iii) an ENTRYCOUNT field 406; and (iv) a CHECKSUM field 408. In other embodiments, different and/or additional fields may be included. It should be noted that the order of the fields in the header is irrelevant, so long as the corresponding Bundle Loader module that is to read this data is programmed appropriately and knows in what order the fields of the header will be provided.

The VERSION field 402 indicates the version number of the Resource Bundle format (e.g. <uint8>). In some embodiments, different versions of Resource Bundle structure or formatting protocol may be utilized or implemented and a Bundle Loader module may be operable to receive and process Resource Bundles formatted in accordance with more than one version. For example, different versions may correspond to different fields and/or a different order of the fields in the data structure. Thus, the VERSION field 402 may be utilized to inform the Bundle Loader module of the version of the structure or formatting protocol that the corresponding Resource Bundle has been generated with, such that the Bundle Loader module may utilize the appropriate processing protocol corresponding to this version. In the example of FIG. 4A, field 402 indicates that the example Resource Bundle corresponds to version “1” of the resource bundle structure or protocol.

The BUNDLELEN field 402 indicates the total size of the Resource Bundle, including the heades, in bytes (e.g., <uint32-be>). In accordance with some embodiments, this information being included in the header of the Resource Bundle allow for progress (e.g., progress in downloading and/or processing of the Resource Bundle) to be reported back to the user or to determine such progress for other purposes. For example, a Bundle Loader module may use this information, along with tracking how many bytes have been processed so far, to calculate the percentage (or other indication or means of measurement) remaining to be processed or downloaded. In some embodiments, an indication of the progress may be indicated to the user (e.g., via progress bar on a user interface).

The ENTRYCOUNT field 406 indicates the number of entries (e.g., resources) included in the Resource Bundle (e.g., <uint32-be>). This information may, in some embodiments, be used as an alternate method for reporting progress (e.g., progress in downloading and/or processing of the bundle) to users or to identify such progress for other purposes. For example, the progress determination may be based on number of resources loaded instead of (or in addition to) being based on bytes.

The CHECKSUM field 408 indicates a BSD (“Berkeley Software Distribution”) checksum of all previous bytes in the header (e.g., <uint16-be>). Although BSD is used as an example, another form of checksum algorithm may be utilized). The checksum allows the Bundle Loader module to verify that the data in the header has been read correctly and that it is indeed a Resource Bundle and not some other data. For example, if the user's device is not compatible with the Bundle Loader module's implementation then the data may be corrupt, and the checksum information data may give an early indication of failure after reading just a small number of bytes (e.g., if VERSION: 1, BUNDELEN: 565, ENTRYCOUNT: 12, CHECKSUM: 24847, then indication of failure may be determined after reading just 11 bytes).

Turning now to FIG. 4B, illustrated therein is a table 400B that is an example data structure for an entry (“ENTRY” in the data arrangement/sequence described above) in a Resource Bundle, wherein each entry contains a resource or data defining a resource. The data for each entry may be utilized for loading and/or processing each resource included in a bundle.

The ENTRYLEN field 410 indicates the size of the entire entry structure as illustrated in table 400B, in bytes (e.g., <uint32-be>). In accordance with some embodiments, because the DATA field 418 (described further below) is of variable size, the ENTRYLEN field needs to come first in each entry. This is so that the Bundle Loader module can determine that it has enough data to process the entry and access the corresponding resource.

The TYPE field 412 indicates the type of resource defined by the entry (e.g., <uint8>; [0=text, 1=json, 2=image, 3=audio]).

The MIME field 414 indicates the type of file defined by the entry (e.g., <Null terminated ascii string>; examples include “image/png” or “audio/mp4”). The MIME type may be used by the Bundle Loader module to, for example, determine how to process the resource. The NAME field 416 indicates the friendly name for the file, such as “example/myImage.png” (e.g., <Null terminated ascii string>). The DATA field 418 stores the data defining the resource of the entry and is variable (e.g., <uint8[ ]>). A Bundle Loader module may be programmed appropriately to look for certain information in certain fields of the data structure of each entry or resource in order to determine how to process the resource (e.g., different types of files or resources may be processed and/or loaded differently and the appropriate subroutine of the loader may be called up based on the data in the fields of the entry for a given resource).

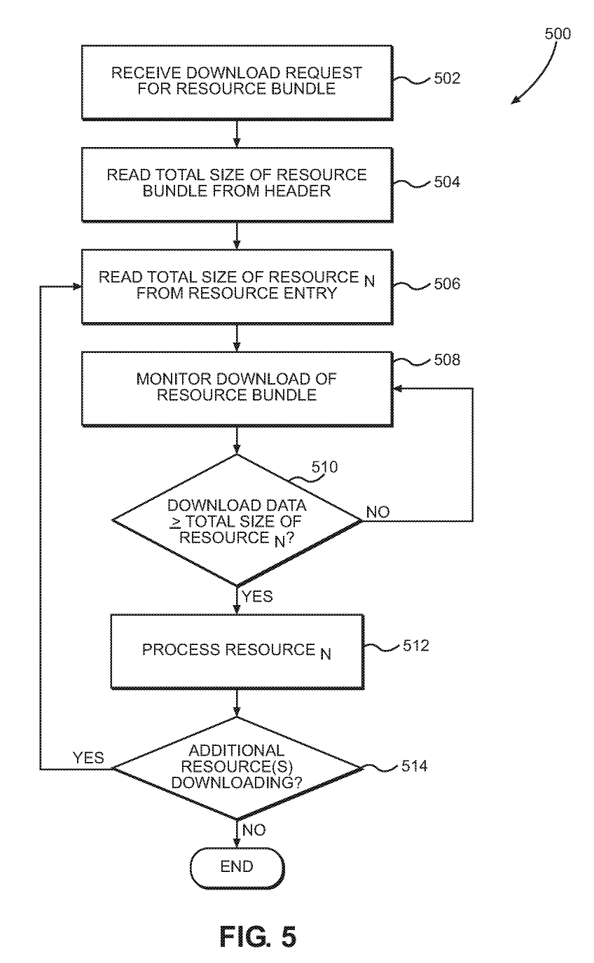

Turning now to FIG. 5 illustrated therein is an example process 500 that may be implemented in accordance with some embodiments. Process 500 may be performed, for example, by a Bundle Loader module (e.g., Bundle Loader module 315A of FIG. 3). It should be noted that the steps and order of steps described with respect to process 500 are for illustrative purposes only. Additional or different steps may, in some embodiments, be included in a similar process.

Process 500 may be initiated by a loader (e.g., a Bundle Loader module such as Bundle Loader module 315A) upon receiving or detecting a download request (step 502). For example, a user of a user device (e.g., a player device, in the context of resources for an online game) on which the module is stored may request to download a Resource Bundle from a server. For example, a player playing an online game comprising program 315 may request to download certain graphics or audio resources for use in the game. In accordance with some embodiments, once the download process is initiated, the loader will pass each resource to the program (e.g., game) as it becomes available from the download (rather than waiting until the entire download is complete before processing and loading the resources into the program), thus performing the processing/loading of the resources in parallel with continuing the download of the Resource Bundle.

In step 504, the total size of the Resource Bundle is read from the header data structure. As described herein (e.g., with reference to FIG. 4A), each Resource Bundle includes a header data structure that indicates to the loader the total size of the Resource Bundle (e.g., in bytes), along with additional information. An example of a data structure for a header of a Resource Bundle has been illustrated and described with reference to FIG. 4A. Then, in step 506, the total size of the first resource (or current resource being downloaded, as the process loops back to step 506 for each resource being downloaded) in the Resource Bundle is read. As described herein, in accordance with some embodiments the data in the bundle file is arranged as follows: <HEADER><ENTRY #1><ENTRY #2><ENTRY #3>, and each byte of a Resource Bundle is downloaded sequentially. Therefor, the loader reads/receives the data sequentially for each entry (resource) and reads each entry's information (e.g., from a data structure such as the example one illustrated in FIG. 4B) as it is downloaded. In such embodiments the loader cannot read information from ENTRY #1 before HEADER had been downloaded, cannot read information from the data structure of ENTRY #3 before ENTRY #2, etc. In a Resource Bundle including a plurality of resources 1-n, reference to the current resource being downloaded at a given point in process 500 will be made as reference to resourceₙ.

In accordance with some embodiments, a loader monitors a download of a Resource Bundle in order to determine whether sufficient data has been downloaded to process/load a resource included in the Resource Bundle (step 506). For example, the loader may checks progress of the download periodically, such as at interval of every 100 ms. In accordance with one embodiment, once the loader determines in step 510 that the downloaded data is at least equal to the total size of the current resource (resources) being downloaded (this latter information having been determined in step 506), it will continue to step 512 and process that resourceₙ and load it to the appropriate program. If the answer to step 510 is no, the loader will continue to monitor the download process (508). As the resourceₙ is processed and loaded in step 512, the loader determines whether additional resources have been downloaded (514), using the data in the data structure of the next resource in the Resource Bundle (step 506; as described above, in a Resource Bundle including resources 1-n, each resource is downloaded sequentially). If there are additional resources in the Resource Bundle (the loader can determine this using the data read in step 504 and the sum of data/resources already downloaded), the process 500 continues again through steps 508-514. If the last resource loaded in step 512 was the last resource in the Resource Bundle, process 500 ends. Thus, as described herein, the novel data structures and protocols described herein for generating a Resource Bundle, in conjunction with an appropriately configured loader that is programmed to recognize, extract and operate on the data in such data structures, allows a processing and loading of resources in a Resource Bundle in parallel with a continued download of the resources in the Resource Bundle.

In one alternate embodiment, similar results can be achieved with modifications to the bundle structure or format. For example, in one embodiment the size of each resource's data may be stored as appearing before the resource data, rather than via the ENTRYLEN variable as described with FIG. 4B above. It should be noted that a Resource Bundle can include resources of any type, it is not limited to the example types described herein (graphic, text, video and audio).

Thus, at least some of the embodiments described herein provide advantages not realized by prior art methodologies. For example, the format and structure of a Resource Bundle and programming of a Bundle Loader module may allow for processing and loading of individual resources included in the bundle prior to the whole bundle being downloaded, thus reducing the total time required for downloading and processing of the resources and allowing the user (e.g., player) to enjoy use of the resources sooner. The methodology of having the Bundle Loader module begin the processing of the data/resources while the downloading of the Resource Bundle continues (streamed) saves time and makes the processing of the data more efficient. Another advantage is that the binary file size comprising a Resource Bundle is typically only slightly larger than the original resource data that is included in the Resource Bundle (as compared to a JSON file, which is typically 33% larger than the underlying data because it does not support binary data and instead requires encoding of the binary data).

It should be understood that any of the software module(s) or computer programs described herein may be part of a single program or integrated into various programs for controlling a processor of a computing device. Further, any of the software module(s) or computer programs described herein may be stored in a compressed, uncompiled, and/or encrypted format and include instructions which, when performed by a processor, cause the processor to operate in accordance with at least some of the methods described herein. Of course, additional and/or different software module(s) or computer programs may be included and it should be understood that the example software module(s) described herein are not necessary in any embodiments. Use of the term “module” is not intended to imply that the functionality described with reference thereto is embodied as a stand-alone or independently functioning program or application. While in some embodiments functionality described with respect to a particular module may be independently functioning, in other embodiments such functionality is described with reference to a particular module for ease or convenience of description only and such functionality may in fact be a part of integrated into another module, program, application, or set of instructions for directing a processor of a computing device.

According to some embodiments, the instructions of any or all of the software module(s) or programs described herein may be read into a main memory from another computer-readable medium, such from a ROM to RAM. Execution of sequences of the instructions in the software module(s) or programs may cause a processor to perform at least some of the process steps described herein. In alternate embodiments, hard-wired circuitry may be used in place of, or in combination with, software instructions for implementation of the processes of the embodiments described herein. Thus, the embodiments described herein are not limited to any specific combination of hardware and software.

The terms ‘computer’, ‘computing device’, ‘computing system’ and ‘computer system’ as used herein unless indicated otherwise refer to any device with processing capability such that it can execute instructions. Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Aspects of the methods described herein may be embodied in programming. Program aspects of the technology may be thought of as “products” or “articles of manufacture” typically in the form of executable code and/or associated data that is carried on or embodied in a type of machine readable medium and/or in a plurality of such media. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fibre optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Although the present embodiments have been described in terms of specific exemplary embodiments, it will be appreciated that various modifications, alterations and/or combinations of features disclosed herein will be apparent to those skilled in the art without departing from the spirit and scope of the invention(s) described herein (e.g., as set forth in the claims appended hereto).

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

What is claimed is:

1. A computer-implemented method of processing a resource bundle downloaded from a server to a user device, the method comprising:
recognizing by a loader a beginning of a download of a resource bundle, the resource bundle comprising a plurality of resources to be loaded for use in a program and wherein a data format for the resource bundle includes:
a header data structure for the resource bundle that includes an indication of a total size of the resource bundle; and
a respective resource data structure for each resource of the plurality of resources, each such resource data structure including an indication of a total size of the resource corresponding to the resource data structure, the indication of the total size of the resource being located in the resource data structure before any data comprising the resource, such that both the total size of the resource bundle and the total size of each resource included in the resource bundle is determinable by the loader before the data comprising the resource is processed;
determining, from the header data structure, the total size of the resource bundle being downloaded;
determining, from the data structure of a first resource included in the resource bundle, a total size of the first resource;
determining, as the resource bundle continues to be downloaded and based on the total size of the resource bundle and the total size of the first resource, that sufficient data has been downloaded to process the first resource, and
process the first resource while the remainder of the resource bundle continues to be downloaded and before the download of the resource bundle is complete.

2. The method of claim 1, wherein processing the first resource comprises loading the first recourse into the program such that it is available for use by the program.

3. The method of claim 1, wherein the loader is a module of the program.

4. The method of claim 1, wherein the loader is a software application corresponding to a first entity and the program is a software application of a second entity.

5. The method of claim 1, wherein the loader and the program are stored locally on the user device.

6. The method of claim 1, wherein the total size of the resource bundle and the total size of the first resource is measured in bytes.

7. The method of claim 1, wherein the total size of the first resource comprises a minimum amount of data required to be downloaded prior to the loader being operable to process the first resource.

8. The method of claim 1, wherein the method further comprises:
monitoring, by the loader, the download of the resource bundle; and
determining, based on the monitoring, that the minimum amount of data required to be downloaded has been downloaded.

9. The method of claim 8, wherein monitoring comprises checking the download process at predetermined intervals.

10. The method of claim 1, wherein the program is an online game program and wherein at least one of the resources comprises at least one of an audio, graphical and video resource for the online game program.

11. A non-transitory computer-readable medium storing instructions comprising a loader mechanism for processing and loading resources to a program, which instructions when executed by a processor cause the processor to:
recognize a beginning of a download of a resource bundle, the resource bundle comprising a plurality of resources to be loaded for use m a program and wherein a data format for the resource bundle includes:
a header data structure for the resource bundle that includes an indication of a total size of the resource bundle; and
a respective resource data structure for each resource of the plurality of resources, each such resource data structure including an indication of a total size of the resource corresponding to the resource data structure, the indication of the total size of the resource being located in the resource data structure before any data comprising the resource, such that both the total size of the resource bundle and the total size of each resource included in the resource bundle is determinable by the loader before the data comprising the resource is processed:
determine, from the header data structure, the total size of the resource bundle being downloaded;
determine, from the data structure of a first resource included in the resource bundle, a total size of the first resource;
determining, as the resource bundle continues to be downloaded and based on the total size of the resource bundle and the total size of the first resource, that sufficient data has been downloaded to process the first resource; and
process the first resource while the remainder of the resource bundle continues to be downloaded and before the download of the resource bundle is complete.

12. The non-transitory computer-readable medium of claim 11, wherein processing the first resource comprises loading the first recourse into the program such that it is available for use by the program.

13. The non-transitory computer-readable medium of claim 11, wherein the loader is a module of the program.

14. The non-transitory computer-readable medium of claim 11, wherein the loader is a software application corresponding to a first entity and the program is a software application of a second entity.

15. The non-transitory computer-readable medium of claim 11, wherein the loader and the program are stored locally on the user device.

16. The non-transitory computer-readable medium of claim 11, wherein the total size of the resource bundle and the total size of the first resource is measured in bytes.

17. The non-transitory computer-readable medium of claim 11, wherein the total size of the first resource comprises a minimum amount of data required to be downloaded prior to the loader being operable to process the first resource.

18. The non-transitory computer-readable medium of claim 11, wherein the method further comprises:
monitoring, by the loader, the download of the resource bundle; and
determining, based on the monitoring, that the minimum amount of data required to be downloaded has been downloaded.

19. The non-transitory computer-readable medium of claim 18, wherein monitoring comprises checking the download process at predetermined intervals.

20. The non-transitory computer-readable medium of claim 11, wherein the program is an online game program and wherein at least one of the resources comprises at least one of an audio, graphical and video resource for the online game program.
